(19) United States
(12) Patent Application Publication
(10) Pub. No.: US 2024/0396237 A1
(43) Pub. Date: Nov. 28, 2024

(54) CONNECTOR

(71) Applicant: SUMITOMO WIRING SYSTEMS, LTD., Mie (JP)

(72) Inventor: Ryohei TSUTSUI, Mie (JP)

(21) Appl. No.: 18/691,236

(22) PCT Filed: Sep. 22, 2022
(86) PCT No.: PCT/JP2022/035304

§ 371 Date: Mar. 12, 2024

(30) Foreign Application Priority Data
Sep. 24, 2021 (JP) 2021-155996

(51) Int. Cl. H01R 9/18; H01R 13/04

(52) U.S. Cl. CPC H01R 9/18; H01R 13/04

(57) ABSTRACT

A connector includes a connector body (20) made of resin, a bus bar (31), and a nut (41). The bus bar (31) is partially embedded in the connector body (20), and a counterpart terminal (50) of a terminal-equipped wire is connected thereto. A bolt (51) configured to fasten the counterpart terminal (50) to the bus bar (31) is screwed to the nut (41). The bus bar (31) includes an extension portion (34) extending out of the connector body (20). The extension portion (34) is fastened to the counterpart terminal (50) using the bolt (51) and the nut (41). Also, the nuts (41) includes an embedded portion (42) embedded inside the connector body (20), and a non-embedded portion (43) located outside the connector body (20).

### TECHNICAL FIELD

The present disclosure relates to a connector.

### BACKGROUND

For example, Patent Document 1 discloses a connector to which a counterpart terminal serving as a connection target is mounted through bolt-fastening. The connector includes a connector body made of resin, and a bus bar that is insert-molded so as to be partially embedded inside the connector body. The bus bar includes an extension portion extending out of the connector body. The counterpart terminal is fastened to the extension portion of the bus bar using a bolt and a nut. Thus, the bus bar and the counterpart terminal are electrically connected to each other. In Patent Document 1 described above, the counterpart terminal is connected to an end portion of a wire having a support-free structure. That is, the counterpart terminal is not a terminal that is provided on a terminal block or the like, but is a terminal that is not supported other than being fixed to the bus bar using the bolt and the nut.

### PRIOR ART DOCUMENT

### Patent Document

Patent Document 1: JP 2017-010640 A

### SUMMARY OF THE INVENTION

### Problems to be Solved

In the case of a connector as described above, if the extension portion of the bus bar rotates together with the counterpart terminal when fastening or removing the bolt, the extension portion of the bus bar may be deformed in a twisted manner. When the counterpart terminal is a terminal of a terminal-equipped wire having a support-free structure as in the case of Patent Document 1 above, the extension portion of the bus bar is particularly likely to be deformed when fastening or removing the bolt.

An object of the present disclosure is to provide a connector that can suppress deformation of a bus bar.

### Means to Solve the Problem

A connector according to the present disclosure includes: a connector body made of resin; a bus bar that is partially embedded in the connector body, and to which a terminal of a terminal-equipped wire is to be connected; and a nut to which a bolt configured to fasten the terminal to the bus bar is to be screwed, wherein the bus bar includes an extension portion extending out of the connector body, and configured to be fastened to the terminal using the bolt and the nut, the nut includes an embedded portion embedded inside the connector body, and a non-embedded portion located outside the connector body.

### Effect of the Invention

According to the present disclosure, it is possible to suppress deformation of a bus bar.

### BRIEF DESCRIPTION OF THE DRAWINGS

FIG. 1 is a cross-sectional side view of a connector according to an embodiment, showing a state in which the connector is mounted to a device case.

FIG. 2 is a perspective view of the connector according to the embodiment.

FIG. 3 is a bottom view of the connector according to the embodiment.

FIG. 4 is a cross-sectional view taken along the line 4-4 in FIG. 3.

FIG. 5 is a cross-sectional view of a connector according to a modification.

### DETAILED DESCRIPTION TO EXECUTE THE INVENTION

### Description of Embodiments of the Present Disclosure

First, embodiments of the present disclosure will be listed and described.

[1] A connector according to the present disclosure includes: a connector body made of resin; a bus bar that is partially embedded in the connector body, and to which a terminal of a terminal-equipped wire is to be connected; and a nut to which a bolt configured to fasten the terminal to the bus bar is to be screwed, wherein the bus bar includes an extension portion extending out of the connector body, and configured to be fastened to the terminal using the bolt and the nut, the nut includes an embedded portion embedded inside the connector body, and a non-embedded portion located outside the connector body.

This configuration enables the connector body to receive the rotational force of the bolt via the embedded portion of the nut when fastening or removing the bolt for fixing the terminal. Accordingly, it is possible to suppress, using the nut including the embedded portion, deformation of the bus bar when fastening or removing the bolt.

[2] The bus bar has a plate shape including the extension portion, the extension portion includes a base portion extending from the connector body in a first direction, and a fastened portion extending from a distal end of the base portion in a direction that intersects the first direction, and having a fastening hole through which the bolt is to be passed, and the non-embedded portion opposes the fastened portion in a through direction of the fastening hole.

With this configuration, the direction of the force acting when fastening the bolt, or in other words, the circumferential direction of the bolt, intersects the planar direction of the base portion. In this case, the base portion is likely to be deformed in a twisted manner by the bolt-fastening force unless some measure is taken. Accordingly, by using the nut including the above-described embedded portion for a configuration in which the fastened portion of the bus bar extends in a direction intersecting the base portion, the effect of the embedded portion in suppressing deformation of the bus bar can be more significantly achieved.

[3] The fastened portion extends in a direction perpendicular to the first direction, and an axial direction of the nut and the through direction of the fastening hole extend in the first direction.

With this configuration, the extension portion of the bus bar that extends out of the connector body includes a base portion, and a fastened portion that forms a right angle with the base portion. In this case, a force acting in a direction orthogonal to the planar direction is applied to the base portion during bolt-fastening. Accordingly, the base portion is particularly likely to be deformed by the bolt-fastening force unless some measure is taken. By using the nut including the above-described embedded portion for such a configuration, the effect of the embedded portion in suppressing deformation of the bus bar can be further significantly achieved.

[4] An outer edge shape of an axially orthogonal cross section of the nut is a polygonal shape.

With this configuration, a cross-sectionally polygonal corner portion of the embedded portion of the nut is caught by the connector body in the circumferential direction. Accordingly, the rotational force of the bolt and the nut can be more suitably received by the connector body.

[5] The connector body includes a primary molded portion that is molded using the bus bar and the nut as inserts, and a secondary molded portion that is molded using the primary molded portion including the bus bar and the nut as an insert. With this configuration, it is possible to suppress deformation of the bus bar in a configuration in which the connector body includes the primary molded portion and the secondary molded portion.

[6] The connector body includes a wall portion configured to bring the terminal into contact with the wall portion when the terminal is fastened to the extension portion using the bolt.

With this configuration, by bringing the terminal into contact with the wall portion during bolt-fastening, the bolt-fastening force can be received by the wall portion via the terminal. This can further suppress deformation of the bus bar.

[7] The connector includes a pair of the bus bars, the wall portion includes a first wall portion corresponding to the terminal that is to be fastened to one of the bus bars, and a second wall portion corresponding to the terminal that is to be fastened to the other bus bar, and the first wall portion is provided between the two bus bars.

With this configuration, deformation of the two bus bars during bolt-fastening can be suppressed by the first wall portion and the second wall portion. Also, the insulation distance between the two bus bars can be ensured by the first wall portion.

[8] The bus bars each have a plate shape including the extension portion, the extension portion includes a base portion extending from the connector body in a first direction, and a fastened portion extending from a distal end of the base portion in a direction that intersects the first direction, and having a fastening hole through which the bolt is to be passed, the non-embedded portion opposes the fastened portion in a through direction of the fastening hole, a dimension of the first wall portion is larger than a dimension of the fastened portion in an extension direction of the fastened portion, and a dimension of the second wall portion is smaller than the dimension of the fastened portion in the extension direction of the fastened portion.

With this configuration, in the extension direction of the fastened portion, the dimension of the first wall portion is larger than the dimension of the fastened portions. Accordingly, it is possible to form a first wall portion that can secure a sufficient insulation distance between the bus bars. On the other hand, the second wall portion does not serve to secure a sufficient insulation distance between the bus bars. Accordingly, by making the dimension of the second wall portion smaller than the dimension of the fastened portion, it is possible to reduce the size of the second wall portion.

[9] The connector body has a bottom surface, the extension portion extends out of the connector body from the bottom surface, and the connector body includes a reinforcing portion that extends from the bottom surface, and that is in contact with the extension portion. With this configuration, deformation of the extension portion of the bus bar can be further suppressed by the reinforcing portion that extends from the connector body.

The reinforcing portion is provided between the non-embedded portion of the nut and the extension portion so as to be in contact with each of the non-embedded portion and the extension portion.

With this configuration, it is possible to provide a structure in which the non-embedded portion of the nut and the extension portion of the bus bar are integrated into a single piece via the reinforcing portion. This can further suppress deformation of the extension portion of the bus bar.

A side surface of the non-embedded portion that is in contact with the reinforcing portion and a side surface of the extension portion that is in contact with the reinforcing portion are parallel to each other.

With this configuration, a mold for molding the connector body can be established while the reinforcing portion, which constitutes a part of the connector body, is set between the non-embedded portion of the nut and the extension portion of the bus bar.

### Details of Embodiments of the Present Disclosure

Specific examples of embodiments of the connector according to the present disclosure will be described below with reference to the drawings. In the drawings, portions of configurations may be shown exaggerated or simplified for convenience of description. In addition, dimensional proportions of the portions may be different from the actual dimensional proportions in the drawings. Being “parallel”, “perpendicular” or “orthogonal” as used herein includes not only being exactly parallel, perpendicular, or orthogonal, but also being substantially parallel, perpendicular, or orthogonal, as long as the operations and effects of the present embodiment can be achieved.

Here, “oppose” as used herein refers to that surfaces or members are located in front of each other, and includes not only a case where they are located fully in front of each other, but also a case where they are located partially in front of each other. Also, the term “oppose” as used herein includes both a case where two portions oppose with a portion other than the two portions interposed therebetween, and a case where two portions oppose with nothing interposed therebetween.

### Overall Configuration

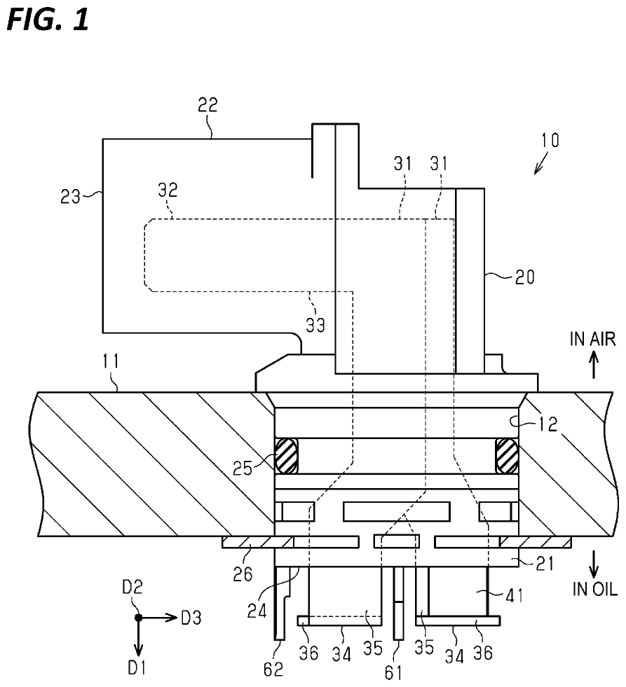

As shown in FIG. 1, a connector 10 according to the present embodiment is mounted to a device case 11. The device case 11 is a transmission case, for example. The connector 10 is electrically connected to a device (not shown) provided inside the device case 11.

The device case 11 has a mounting hole 12, for example. The mounting hole 12 is formed so as to allow communication between an internal space of the device case 11 and an external space of the device case 11. The connector 10 is fitted to the mounting hole 12. Note that the internal space of the device case 11 serving as a transmission case is in an oil environment, and the external space of the device case 11 is in an air environment.

### Connector 10

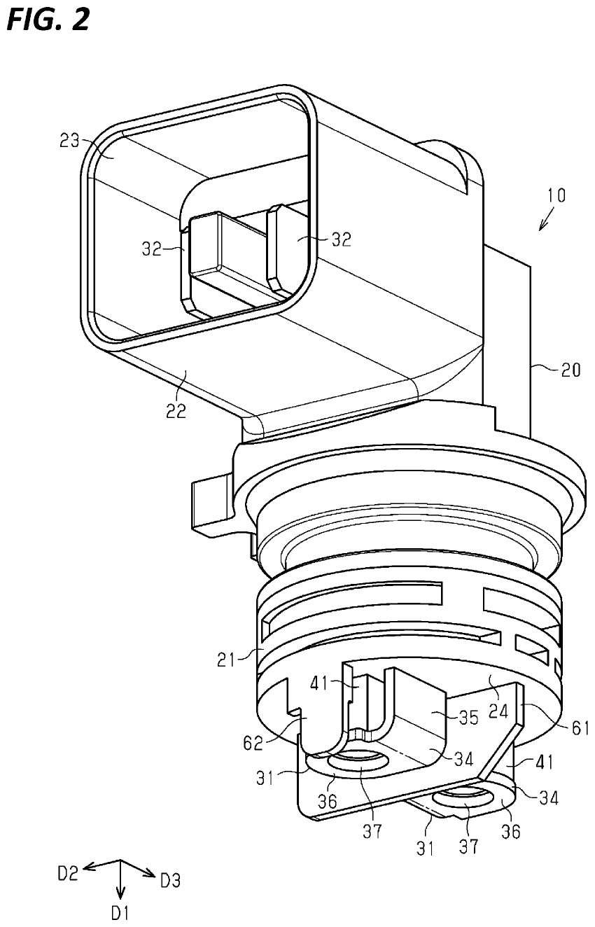

As shown in FIG. 2, the connector 10 includes a connector body 20 made of resin, two bus bars 31, and two nuts 41.

As shown in FIGS. 1 and 2, the connector body 20 includes a primary molded portion 21 and a secondary molded portion 22, for example. The primary molded portion 21 is molded using the bus bars 31 and the nuts 41 as inserts. The primary molded portion 21 is formed so as to cover a part of each of the bus bars 31 and a part of each of the nuts 41.

The secondary molded portion 22 is formed using the primary molded portion 21 including the bus bars 31 and the nuts 41 as an insert. The secondary molded portion 22 is formed so as to cover a part of the primary molded portion 21. The secondary molded portion 22 includes a fitting portion 23 to which a counterpart connector (not shown) is to be fitted.

As shown in FIG. 1, in a state in which the connector 10 is mounted to the device case 11, a part of the secondary molded portion 22 that includes the fitting portion 23 is located outside the device case 11, another part of the secondary molded portion 22 is located in the mounting hole 12. On the other hand, a part of the primary molded portion 21 is located in the mounting hole 12, and another part of the primary molded portion 21 that includes a bottom surface 24 is located inside the device case 11, or in other words, in oil.

A sealing ring 25 such as an O-ring is mounted to an outer circumferential surface of the secondary molded portion 22 that is located in the mounting hole 12. The sealing ring 25 is in close contact with the entire inner circumferential surface of the mounting hole 12 in the circumferential direction, and provides a seal between the outer circumferential surface of the secondary molded portion 22 and an inner circumferential surface of the device case 11. A C-ring 26 in contact with an inner surface of the device case 11 is mounted to an outer circumferential surface of the primary molded portion 21.

### Bus Bars 31

Each of the bus bars 31 includes a connection portion 32 configured to be connected to a terminal of the counterpart connector. The connection portion 32 is configured to be exposed to the outside of the connector body 20 in the fitting portion 23.

Each of the bus bars 31 has an overall plate shape, for example. Each of the bus bars 31 is molded by pressing a metal plate, for example. Each of the bus bars 31 includes a buried portion 33 that is buried inside the connector body 20, and an extension portion 34 extending out of the connector body 20 from the bottom surface 24 of the primary molded portion 21. The extension portion 34 and the connection portion 32 are respectively located at two opposite ends of the corresponding bus bar 31.

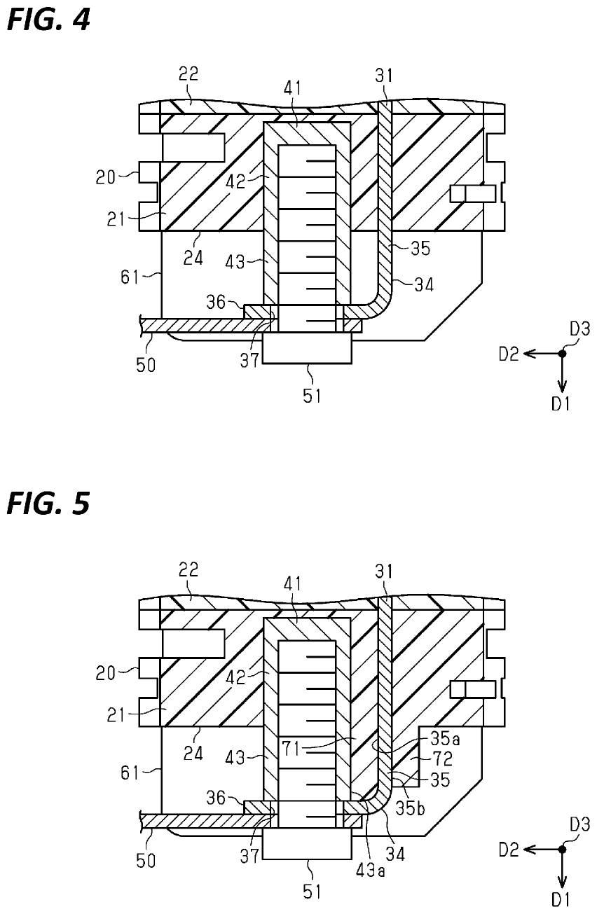

As shown in FIGS. 2 and 4, the extension portion 34 has a plate shape. The extension portion 34 includes a base portion 35 extending from the bottom surface 24 in a first direction D1, and a fastened portion 36 extending from a distal end of the base portion 35. The bottom surface 24 has, for example, a planar shape that is perpendicular to the first direction D1. The fastened portion 36 is formed by bending the base portion 35. The fastened portion 36 extends in a direction intersecting the first direction D1. In the present embodiment, the fastened portion 36 extends in a second direction D2 that is orthogonal to the first direction D1. The fastened portion 36 opposes the bottom surface 24 in the first direction D1.

Each counterpart terminal 50 shown in FIG. 4 is fastened and fixed to the corresponding fastened portion 36 using a bolt 51 and a nut 41. The counterpart terminal 50 is provided at an end portion of a terminal-equipped wire 52 having a support-free structure. That is, the counterpart terminal 50 is not a terminal provided on a terminal block or the like, but is a terminal having no support portion other than being fixed to the corresponding bus bar 31 using the bolt 51 and the nut 41.

Each fastened portion 36 includes a fastening hole 37 through which a bolt 51 is to be passed. The fastening hole 37 extends through the fastened portion 36 in a plate thickness direction. That is, the fastening hole 37 extends through the fastened portion 36 in the first direction D1. The respective fastened portions 36 of the two bus bars 31 are arranged in a third direction D3 that is orthogonal to each of the first direction D1 and the second direction D2. The directions in which the fastened portions 36 extend from the corresponding base portions 35 are opposite to each other, for example.

### Nut 41

The nuts 41 are provided so as to respectively correspond to the two bus bars 31. An axial direction of the nuts 41 extends in the first direction D1, for example. Each of the nuts 41 includes an embedded portion 42 that is embedded inside the connector body 20, and a non-embedded portion 43 that is located outside the connector body 20. The embedded portion 42 is embedded in the primary molded portion 21, for example. The non-embedded portion 43 protrudes to the outside from the bottom surface 24 of the primary molded portion 21. The embedded portion 42 and the non-embedded portion 43 are arranged in the axial direction of the nut 41.

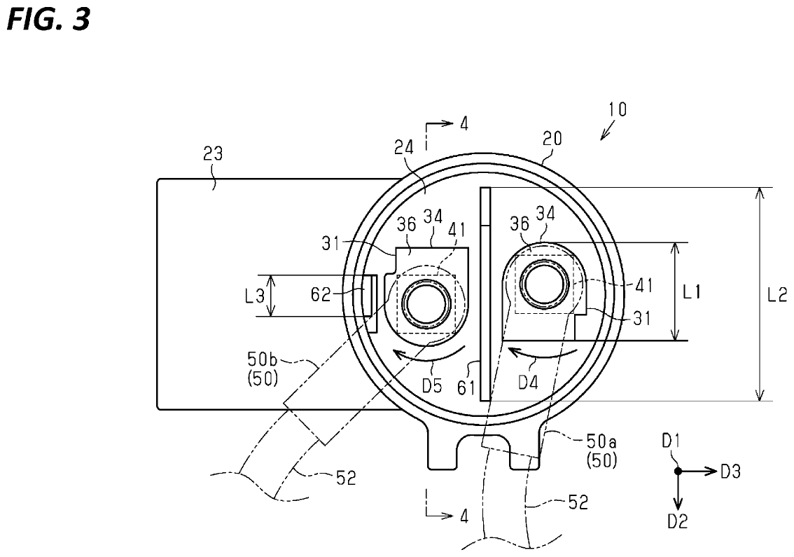

As shown in FIG. 3, an outer edge shape of an axially orthogonal cross section of each of the nuts 41 is polygonal. In the present embodiment, the outer edge shape of the nut 41 is a square shape. The outer edge shape of the nut 41 is uniform in the axial direction of the nut 41, for example. That is, the outer edge shape of an axially orthogonal cross section of the embedded portion 42 is a square shape. The outer edge shape of an axially orthogonal cross section of the non-embedded portion 43 is also a square shape. On at least an outer circumferential surface of the embedded portion 42, the nut 41 has an uneven structure formed through diamond knurling, for example. Accordingly, the resin of the primary molded portion 21 enters the uneven structure of the outer circumferential surface of the nut 41, thus increasing the strength of the connection between the embedded portion 42 of the nut 41 and the primary molded portion 21.

As shown in FIG. 4, each non-embedded portion 43 opposes the corresponding fastened portion 36 in the through direction of the corresponding fastening hole 37, or in other words, in the first direction D1. In the present embodiment, the non-embedded portion 43 is in contact with the fastened portion 36 in the through direction of the fastening hole 37. The non-embedded portion 43 may be simply in contact with the fastened portion 36, or may be fixed to the fastened portion 36 using, for example, an adhesive or the like. Note that a potting material (not shown) for suppressing the oil in the device case 11 from leaking to the outside of the device case 11 is provided around the extension portion 34 of each of the bus bars 31 and the embedded portion 42 of each of the nuts 41. In a state in which each fastened portion 36 is not fixed to the corresponding counterpart terminal 50 using a bolt 51, the non-embedded portion 43 of a nut 41 is in contact with the fastened portion 36, for example.

### First Wall Portion 61 and Second Wall Portion 62

As shown in FIG. 2, the connector body 20 includes a first wall portion 61 and a second wall portion 62. Each of the first wall portion 61 and the second wall portion 62 protrudes in the first direction D1 from the bottom surface 24 of the primary molded portion 21, for example.

Here, as shown in FIG. 3, it is assumed that a counterpart terminal 50 that is fastened to one of the two bus bars 31 is a first counterpart terminal 50a, and a counterpart terminal 50 that is fastened to the other bus bar 31 is a second counterpart terminal 50b. The first wall portion 61 is provided so as to correspond to the first counterpart terminal 50a. The second wall portion 62 is provided so as to correspond to the second counterpart terminal 50b.

The first wall portion 61 is provided between the two fastened portions 36. The first wall portion 61 has a plate shape extending in the second direction D2, for example. The first wall portion 61 also functions to secure an insulation distance between the extension portions 34 of the bus bars 31. The first wall portion 61 is configured to come into contact with the first counterpart terminal 50a when the first counterpart terminal 50a is fastened to the corresponding bus bar 31 using a bolt 51. This enables the first wall portion 61 to receive, during bolt-fastening, the force of the first counterpart terminal 50a rotating in a clockwise fastening rotation direction D4 about the bolt 51.

The second wall portion 62 is provided at a position that opposes the first wall portion 61 across the bus bar 31 fastened to the second counterpart terminal 50b. The second wall portion 62 has a plate shape that extends in the second direction D2, for example. The second wall portion 62 is configured to come into contact with the second counterpart terminal 50b when the second counterpart terminal 50b is fastened to the corresponding bus bar 31 using a bolt 51. This enables the second wall portion 62 to receive, during bolt-fastening, the force of the second counterpart terminal 50b rotating in a clockwise fastening rotation direction D5 about the bolt 51.

The dimensions (lengths) of the bus bars 31 in the extension direction of the fastened portions 36, or in other words, their dimensions in the second direction D2, are set to be substantially equal. Also, in the second direction D2, a dimension L2 of the first wall portion 61 is larger than a dimension L1 of the fastened portions 36 of the bus bars 31. In this direction, a dimension L3 of the second wall portion 62 is smaller than the dimension L1 of the fastened portions 36 of the bus bars 31. That is, in this direction, the dimension L3 of the second wall portion 62 is smaller than the dimension L2 of the first wall portion 61.

The operations of the present embodiment will be described.

When bolt-fastening the first counterpart terminal 50a to the corresponding bus bar 31, the first counterpart terminal 50a is brought into contact with the first wall portion 61 in the fastening rotation direction D4. This allows the first wall portion 61 to receive the force acting in the fastening rotation direction D4. As a result, during bolt-fastening, it is possible to suppress the first counterpart terminal 50a and the extension portion 34 of the bus bar 31 from rotating together in the fastening rotation direction D4.

When bolt-fastening the second counterpart terminal 50b to the corresponding bus bar 31, the second counterpart terminal 50b is brought into contact with the second wall portion 62 in the fastening rotation direction D5. This allows the second wall portion 62 to receive the force acting in the fastening rotation direction D5. As a result, during bolt-fastening, it is possible to suppress the second counterpart terminal 50b and the extension portion 34 of the bus bar 31 from rotating together in the fastening rotation direction D5.

Furthermore, in the present embodiment, each of the nuts 41 includes an embedded portion 42 that is embedded in the connector body 20. Accordingly, the rotating force acting during bolt-fastening can be received ty the connector body 20 via the embedded portion 42. This can further suppress the extension portion 34 of each of the bus bars 31 from rotating during bolt-fastening.

Although a force acting in a counterclockwise direction about a bolt 51 is applied to the extension portion 34 of each of the bus bars 31 when removing the bolt 51, this force can also be received by the connector body 20 via the embedded portion 42 of a nut 41. Accordingly, it is also possible, with the embedded portion 42, to suppress the extension portion 34 of the bus bar 31 from rotating when removing the bolt 51.

The effects of the present embodiment will be described.

(1) The extension portion 34 of each bus bar 31 extending out of the connector body 20 is fastened to the corresponding counterpart terminal 50 using a bolt 51 and a nut 41. Also, the nut 41 includes an embedded portion 42 that is embedded inside the connector body 20, and a non-embedded portion 43 located outside the connector body 20. This configuration enables the connector body 20 to receive the rotational force of the bolt 51 via the embedded portion 42 of the nut 41 when fastening or removing the bolt 51. Accordingly, it is possible to suppress, using the nut 41 including the embedded portion 42, deformation of the bus bar 31 when fastening or removing the bolt 51.

(2) Each bus bar 31 has a plate shape including the extension portion 34. The extension portion 34 includes a base portion 35 extending from the connector body 20 in the first direction D1, and a fastened portion 36 having a fastening hole 37 through which a bolt 51 is to be passed. The fastened portion 36 extends from a distal end of the base portion 35 in a direction intersecting the first direction D1. Also, the non-embedded portion 43 of the nut 41 opposes the fastened portion 36 in the through direction of the fastening hole 37. With this configuration, the direction of the force acting when fastening the bolt 51, or in other words, the circumferential direction of the bolt 51, intersects the planar direction of the base portion 35. In this case, the base portion 35 is likely to be deformed in a twisted manner by the bolt-fastening force unless some measure is taken. Accordingly, by using the nut 41 including the embedded portion 42 for a configuration in which the fastened portion 36 of the bus bar 31 extends in a direction intersecting the base portion 35, the effect of the embedded portion 42 in suppressing deformation of the bus bar 31 can be more significantly achieved.

(3) The fastened portion 36 extends in a direction perpendicular to the first direction D1. Also, the axial direction of the nut 41 and the through direction of the fastening hole 37 extend in the first direction D1. With this configuration, the extension portion 34 of each bus bar 31 that extends out of the connector body 20 includes a base portion 35, and a fastened portion 36 that forms a right angle with the base portion 35. In this case, a force acting in a direction orthogonal to the planar direction is applied to the base portion 35 during bolt-fastening. Accordingly, the base portion 35 is particularly likely to be deformed by the bolt-fastening force unless some measure is taken. By using the nut 41 including the embedded portion 42 for such a configuration, the effect of the embedded portion 42 in suppressing deformation of the bus bar 31 can be further significantly achieved.

(4) An outer edge shape of an axially orthogonal cross section of the nut 41 has a polygonal shape. With this configuration, the cross-sectionally polygonal corner portion of the embedded portion 42 of each nut 41 is caught by the connector body 20 in the circumferential direction. Accordingly, the rotational force of a bolt 51 and the nut 41 can be more suitably received by the connector body 20.

(5) The connector body 20 includes a primary molded portion 21 that is molded using the bus bars 31 and the nuts 41 as inserts, and a secondary molded portion 22 that is molded using the primary molded portion 21 including the bus bars 31 and the nuts 41 as an insert. With this configuration, it is possible to suppress deformation of the bus bars 31 in a configuration in which the connector body 20 includes the primary molded portion 21 and the secondary molded portion 22.

(6) The connector body 20 includes a first wall portion 61 and a second wall portion 62 configured to bring the counterpart terminals 50 into contact respectively with the first wall portion 61 and the second wall portion 62 when the counterpart terminals 50 are fastened to the corresponding extension portions 34 using the bolts 51. With this configuration, by bringing the counterpart terminals 50 into contact respectively with the first wall portion 61 and the second wall portion 62 during bolt-fastening, the bolt-fastening force can be received by the first wall portion 61 and the second wall portion 62 via the counterpart terminals 50. This can further suppress deformation of the bus bars 31.

(7) The first wall portion 61 is provided between the two bus bars 31. With this configuration, the insulation distance between the two bus bars 31 can be secured by the first wall portion 61.

(8) In the extension direction of the fastened portion 36, the dimension L2 of the first wall portion 61 is larger than the dimension L1 of the fastened portions 36. Accordingly, it is possible to form a first wall portion 61 that can secure a sufficient insulation distance between the bus bars 31. On the other hand, the second wall portion 62 does not serve to secure a sufficient insulation distance between the bus bars 31. Accordingly, by making the dimension L3 of the second wall portion 62 smaller than the dimension L1 of the fastened portion 36, it is possible to reduce the size of the second wall portion, which in turn can contribute to, for example, a reduction in weight of the connector 10.

The present embodiment can be implemented with the following modifications. The present embodiment and the following modifications can be implemented in combination with each other as long as there are no technical discrepancies.
In the above embodiment, it is possible to provide a reinforcing portion that extends from the bottom surface 24 of the primary molded portion 21, and that is in contact with the extension portion 34 of each of the bus bars 31. For example, the connector body 20 shown in FIG. 5 includes a first reinforcing portion 71 and a second reinforcing portion 72. Each of the first reinforcing portion 71 and the second reinforcing portion 72 extends from the bottom surface 24 of the primary molded portion 21 along the base portion 35 of each of the bus bars 31. The first reinforcing portion 71 and the second reinforcing portion 72 are formed as a single piece with the primary molded portion 21.

The first reinforcing portion 71 is interposed between each base portion 35 and the non-embedded portion 43 of each nut 41. For example, the first reinforcing portion 71 fills a space defined by the base portion 35 and the non-embedded portion 43. That is, the first reinforcing portion 71 is in contact with each of the base portion 35 and the non-embedded portion 43.

Here, a side surface of the base portion 35 that is in contact with the first reinforcing portion 71 is denoted as a side surface 35a. A side surface of a cross-sectionally square non-embedded portion 43 that is in contact with the first reinforcing portion 71 is denoted as a side surface 43a. The side surface 35a of the base portion 35 and the side surface 43a of the non-embedded portion 43 are parallel to each other. This can prevent a portion into which a resin for forming the first reinforcing portion 71 does not flow from being formed between the side surface 35a of the base portion 35 and the side surface 43a of the non-embedded portion 43 when molding the primary molded portion 21.

The second reinforcing portion 72 is in contact with a side surface 35b of the base portion 35 that is opposite to the side surface 35a. That is, the first reinforcing portion 71 and the second reinforcing portion 72 are formed so as to sandwich the base portion 35 therebetween in the second direction D2.

According to the above-described example, the connector body 20 includes the first reinforcing portion 71 and the second reinforcing portion 72 that extend from the bottom surface 24, and that are in contact with the extension portion 34. With this configuration, deformation of the extension portion 34 of each of the bus bars 31 can be further suppressed by the first reinforcing portion 71 and the second reinforcing portion 72 that extend from the connector body 20.

The first reinforcing portion 71 is provided between the non-embedded portion 43 of a nut 41 and the extension portion 34 of the corresponding bus bar 31 so as to be in contact with each of the non-embedded portion 43 and the extension portion 34. With this configuration, it is possible to provide a structure in which the non-embedded portion 43 of the nut 41 and the extension portion 34 of the bus bar 31 are integrated into a single piece via the first reinforcing portion 71. This can further suppress deformation of the extension portion 34 of the bus bar 31.

The side surface 43a of the non-embedded portion 43 that is in contact with the first reinforcing portion 71, and the side surface 35a of the extension portion 34 that is in contact with the first reinforcing portion 71 are parallel to each other. With this configuration, a mold for molding the connector body 20 can be established while the first reinforcing portion 71, which constitutes a part of the connector body 20, is set between the non-embedded portion 43 and the extension portion 34.

The example shown in FIG. 5 illustrates a configuration in which the connector body 20 includes the first reinforcing portion 71 and the second reinforcing portion 72 as the reinforcing portions. Instead, either one of the first reinforcing portion 71 and the second reinforcing portion 72 may be omitted, for example.
In the above embodiment, the fastened portions 36 of the bus bars 31 may extend from the respective base portions 35 in the same direction.
The outer edge shape of the axially orthogonal cross section of the nuts 41 is not limited to the example described in the above embodiment, and may be changed to, for example, a quadrangular shape other than a square shape, or a polygonal shape other than a quadrangular shape.
Although the connector body 20 of the above embodiment includes the primary molded portion 21 and the secondary molded portion 22, the present disclosure is not limited thereto. For example, a connector body 20 may be formed using only a primary molded portion.
The angle formed by the base portion 35 and the fastened portion 36 of each of the bus bars 31 is not limited to the example described in the above embodiment, and may be larger than 90 degrees, for example.
The numbers of bus bars 31 and nuts 41 of the connector 10 are not limited to those of the example described in the above embodiment, and may be modified as appropriate according to the configuration of the connector 10.
The above embodiment is implemented as a connector 10 configured to be mounted to a transmission case. However, the present disclosure is not limited thereto, and may be applied to a connector for use other than that for a transmission case.
As shown in FIG. 3, each of the counterpart terminals 50 may be provided at a free end of a terminal-equipped wire 52.
As shown in FIG. 1, each of the first wall portion 61 and the second wall portion 62 may protrude from the bottom surface 24 of the primary molded portion 21 in the first direction D1, to an extent greater than the fastened portions 36 of the extension portions 34.
As shown in FIG. 4, each nut 41 may have a tubular shape that is closed at one end. The embedded portion 42 may include the closed end of the nut 41, and the non-embedded portion 43 may include an open end of the nut 41. The length of the embedded portion 42 in the axial direction of the nut 41 may be substantially equal to the length of the non-embedded portion 43, or may be longer than the length of the non-embedded portion 43. That is, half the length or more of the nut 41 in the axial direction may be embedded in the connector body 20. As shown in FIG. 2, the outer circumferential surface of each nut 41 may include a plane that is parallel to the base portion 35 of the corresponding bus bar 31.
The present disclosure encompasses the following implementation examples. Reference numerals are assigned to some of the constituent elements of the exemplary embodiments, not for limiting purpose, but for better understanding. Some of the matters described in the following implementation examples may be omitted, and some of the matters described in the implementation examples may be selected or extracted for combination.

[Appendix 1] In an aspect of the present disclosure, the nut (41) may have a tubular shape that is closed at one end, the embedded portion (42) may include the closed end of the nut (41), and the non-embedded portion (43) may include an open end of the nut (41).

[Appendix 2] In an aspect of the present disclosure, the length of the embedded portion (42) in the axial direction of the nut (41) may be substantially equal to the length of the non-embedded portion (43), or may be longer than the length of the non-embedded portion (43).
The embodiments and modifications disclosed herein are to be construed in all respects as illustrative, and the present invention is not limited thereto. That is, the scope of the present invention is defined by the claims and is intended to include all modifications which fall within the scope of the claims and the meaning and scope of equivalents thereof.

### LIST OF REFERENCE NUMERALS

10 Connector
11 Device case
12 Mounting hole
20 Connector body
21 Primary molded portion
22 Secondary molded portion
23 Fitting portion
24 Bottom surface
25 Sealing ring
26 C-ring
31 Bus bar
32 Connection portion
33 Buried portion
34 Extension portion
35 Base portion
35a Side surface
35b Side surface
36 Fastened portion
37 Fastening hole
41 Nut
42 Embedded portion
43 Non-embedded portion
43a Side surface
50 Counterpart terminal (terminal)
50a First counterpart terminal (terminal)
50b Second counterpart terminal (terminal)
51 Bolt
52 Terminal-equipped wire
61 First wall portion (wall portion)
62 Second wall portion (wall portion)
71 First reinforcing portion (reinforcing portion)
72 Second reinforcing portion (reinforcing portion)
D1 First direction
D2 Second direction
D3 Third direction
D4 Fastening rotation direction
D5 Fastening rotation direction
L1 Dimension
L2 Dimension
L3 Dimension

1. A connector comprising:
a connector body made of resin;
a bus bar that is partially embedded in the connector body, and to which a terminal of a terminal-equipped wire is to be connected; and
a nut to which a bolt configured to fasten the terminal to the bus bar is to be screwed,
wherein the bus bar includes an extension portion extending out of the connector body, and configured to be fastened to the terminal using the bolt and the nut,
the nut includes an embedded portion embedded inside the connector body, and a non-embedded portion located outside the connector body.

2. The connector according to claim 1,
wherein the bus bar has a plate shape including the extension portion,
the extension portion includes a base portion extending from the connector body in a first direction, and a fastened portion extending from a distal end of the base portion in a direction that intersects the first direction, and having a fastening hole through which the bolt is to be passed, and
the non-embedded portion opposes the fastened portion in a through direction of the fastening hole.

3. The connector according to claim 2,
wherein the fastened portion extends in a direction perpendicular to the first direction, and
an axial direction of the nut and the through direction of the fastening hole extend in the first direction.

4. The connector according to claim 1,
wherein an outer edge shape of an axially orthogonal cross section of the nut is a polygonal shape.

5. The connector according to claim 1,
wherein the connector body includes a primary molded portion that is molded using the bus bar and the nut as inserts, and a secondary molded portion that is molded using the primary molded portion including the bus bar and the nut as an insert.

6. The connector according to claim 1,
wherein the connector body includes a wall portion configured to bring the terminal into contact with the wall portion when the terminal is fastened to the extension portion using the bolt.

7. The connector according to claim 6,
wherein the connector comprises a pair of the bus bars,
the wall portion includes a first wall portion corresponding to the terminal that is to be fastened to one of the bus bars, and a second wall portion corresponding to the terminal that is to be fastened to the other bus bar, and
the first wall portion is provided between the two bus bars.

8. The connector according to claim 7,
wherein the bus bars each have a plate shape including the extension portion,
the extension portion includes a base portion extending from the connector body in a first direction, and a fastened portion extending from a distal end of the base portion in a direction that intersects the first direction, and having a fastening hole through which the bolt is to be passed,
the non-embedded portion opposes the fastened portion in a through direction of the fastening hole,
a dimension of the first wall portion is larger than a dimension of the fastened portion in an extension direction of the fastened portion, and
a dimension of the second wall portion is smaller than the dimension of the fastened portion in the extension direction of the fastened portion.

91. The connector according to claim 1,
wherein the connector body has a bottom surface,
the extension portion extends out of the connector body from the bottom surface, and
the connector body includes a reinforcing portion that extends from the bottom surface, and that is in contact with the extension portion.

10. The connector according to claim 9,
wherein the reinforcing portion is provided between the non-embedded portion of the nut and the extension portion so as to be in contact with each of the non-embedded portion and the extension portion.

11. The connector according to claim 10,
wherein a side surface of the non-embedded portion that is in contact with the reinforcing portion and a side surface of the extension portion that is in contact with the reinforcing portion are parallel to each other.
